(19) United States
(12) Patent Application Publication
(10) Pub. No.: US 2025/0132933 A1
(43) Pub. Date: Apr. 24, 2025

(54) METAVERSE COLLABORATIVE ENVIRONMENT MONITORING

(71) Applicant: International Business Machines Corporation, Armonk, NY (US)

(72) Inventors: Saraswathi Sailaja Perumalla, Visakhapatnam (IN); Sudheesh S. Kairali, Kozhikode (IN); Sarbajit K. Rakshit, Kolkata (IN); Pavan Kumar Penugonda, anakapalle (IN)

(21) Appl. No.: 18/492,826

(22) Filed: Oct. 24, 2023

(51) Int. Cl. H04L 9/40; G06V 20/52; H04L 12/18

(52) U.S. Cl. CPC H04L 9/40; G06N 3/0475

(57) ABSTRACT

Embodiments are related to metaverse collaborative environment monitoring. An aspect includes providing a virtual room in a virtual environment, a content in the virtual room initially being excluded from monitoring. An aspect includes monitoring a context associated with the virtual room and determining that the context of the virtual room meets at least one condition. An aspect includes deploying at least one virtual camera for monitoring the content in the virtual room, in response to determining that the context of the virtual room meets the at least one condition. Participants are alerted in the virtual room that monitoring is occurring in the virtual room.

### BACKGROUND

The present invention generally relates to computer systems, and more specifically, to computer-implemented methods, computer systems, and computer program products configured and arranged for providing metaverse collaborative environment monitoring.

Virtual reality (VR) or augmented reality (AR) environments have been around for a number of years. VR or AR may refer to simulated environments featuring computer graphics that a user can interact with in a way that is more immersive than merely watching a television or computer screen. In typical VR environments, the user would utilize some external set of controllers, such as a joystick or interactive glove, in order to move around in the VR environment. Other implementations of VR have included VR goggles, which are head-mounted devices that a user can wear over his/her eyes. The user can then see the equivalent of a panoramic view, and the user may manipulate the environment seen through the goggles by using some external device, like a joystick or some other controller. AR implementations blend computer graphics and other images with a user's actual surroundings, such that the user may perceive that his/her surroundings have been augmented. To achieve this, AR goggles that the user may wear typically provide transparent or substantially transparent lenses, so that the user can still see his/her actual surroundings while viewing other virtual objects at the same time.

### SUMMARY

Embodiments of the present invention are directed to computer-implemented methods for providing metaverse collaborative environment monitoring. A non-limiting computer-implemented method includes providing a virtual room in a virtual environment, a content in the virtual room initially being excluded from monitoring. The method includes monitoring a context associated with the virtual room and determining that the context of the virtual room meets at least one condition. The method includes deploying at least one virtual camera for monitoring the content in the virtual room, in response to determining that the context of the virtual room meets the at least one condition, and alerting participants in the virtual room that monitoring is occurring in the virtual room.

Other embodiments of the present invention implement features of the above-described methods in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computing environment for use in conjunction with one or more embodiments of the present invention;

FIG. 2 depicts a block diagram of the example computing environment configured for providing metaverse collaborative environment monitoring according to one or more embodiments of the present invention;

FIGS. 3A and 3B depict a flowchart of a computer-implemented method for monitoring in a metaverse collaborative environment upon a trigger and performing actions to alleviate a violation according to one or more embodiments of the present invention;

FIG. 4 depicts an example metaverse collaborative environment before monitoring according to one or more embodiments of the present invention;

FIG. 5 depicts an example metaverse collaborative environment with monitoring according to one or more embodiments of the present invention; and

FIG. 6 depicts a flowchart of a computer-implemented method for monitoring in a metaverse collaborative environment upon a trigger and performing actions to stop a violation in the metaverse collaborative environment according to one or more embodiments of the present invention.

### DETAILED DESCRIPTION

One or more embodiments of the invention describe computer-implemented methods, computer systems, and computer program products configured and arranged for monitoring a metaverse collaborative environment upon a condition being met and performing actions to alleviate or stop a violation in the metaverse collaborative environment.

A metaverse is a network of three-dimensional (3D) virtual worlds focused on social connection. In many cases, a metaverse is often described as an iteration of the Internet as a single, universal virtual world that is facilitated by the use of virtual reality (VR) and augmented reality (AR) headsets. In the metaverse collaborative environment, people across the world can collaborate with each other and view their avatars. In the metaverse collaborative environment, different people can collaborate and perform virtual gatherings, meetings, etc., and the consequence can also be a security threat. For example, participants in the metaverse collaborative environment may be planning cyberattack and/or engaging in a cyberattack. For safety purposes, one or more embodiments are configured to provide the presence of virtual security in the metaverse collaborative environment upon a condition being met, such that the metaverse collaboration service provider can ensure compliance with any rules, regulations, and/or service agreements.

According to one or more embodiments, an artificial intelligence (AI) system is enabled by the metaverse collaboration service providers to analyze the context of any metaverse collaborations, and accordingly one or more virtual cameras are paced in different portions of the metaverse collaborative surrounding, so that the metaverse collaboration can be monitored. The monitored content of the metaverse collaborative environment is analyzed, and the service provider is notified if any anomaly is identified in the monitored content. Based on the context of any metaverse collaboration, the AI enabled metaverse collaboration service provider can deploy one or more virtual security and/or volunteers in the metaverse collaborative environment, according to one or more embodiments. The virtual security and/or volunteers are placed in the metaverse collaborative environment along with the virtual cameras, and the virtual cameras and virtual security capture the surroundings of the metaverse collaborative environment. Once the virtual cameras and/or virtual security are deployed in the metaverse collaborative environment, the system notifies the participants present in the metaverse collaborative environment that the monitoring is occurring. Additionally, based on a change in the context of metaverse collaboration, the system is configured to dynamically change the coverage of virtual cameras and virtual security, so that the monitoring of the metaverse collaboration is aligned with the change in metaverse collaboration context.

According to one or more embodiments, the system can use a smart contract rule to identify when the metaverse collaboration is to be monitored, and the smart contract rule can be defined by the metaverse collaboration service providers to meet the compliance of any rules, regulations, and/or service agreements. In one or more embodiments, the system can use a blockchain ledger to track which metaverse collaborative environment is monitored, the monitoring coverage, duration of monitoring, and any anomaly that is identified in the collaborative environment. Authorized administrators are able to view the anomalies.

One or more embodiments described herein can utilize machine learning techniques to perform tasks, such as classifying a feature of interest. More specifically, one or more embodiments described herein can incorporate and utilize rule-based decision making and artificial intelligence (AI) reasoning to accomplish the various operations described herein, namely classifying a feature of interest. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” “a trained classifier,” and/or “trained machine learning model”) can be used for classifying a feature of interest, for example. In one or more embodiments, machine learning functionality can be implemented using an Artificial Neural Network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional Neural Networks (CNN) are a class of deep, feed-forward ANNs that are particularly useful at tasks such as, but not limited to analyzing visual imagery and natural language processing (NLP). Recurrent Neural Networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as interactive software code 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

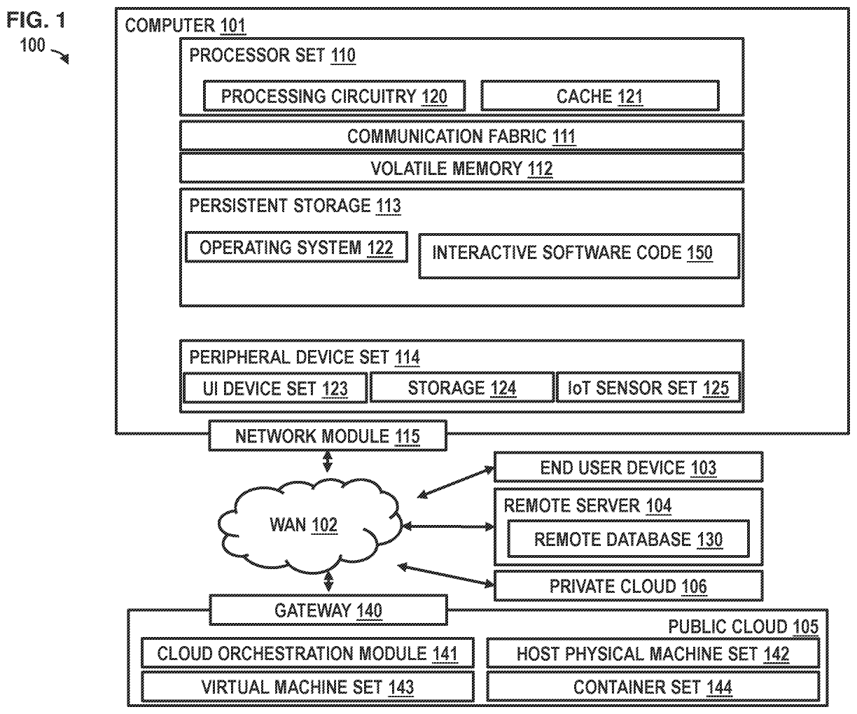

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

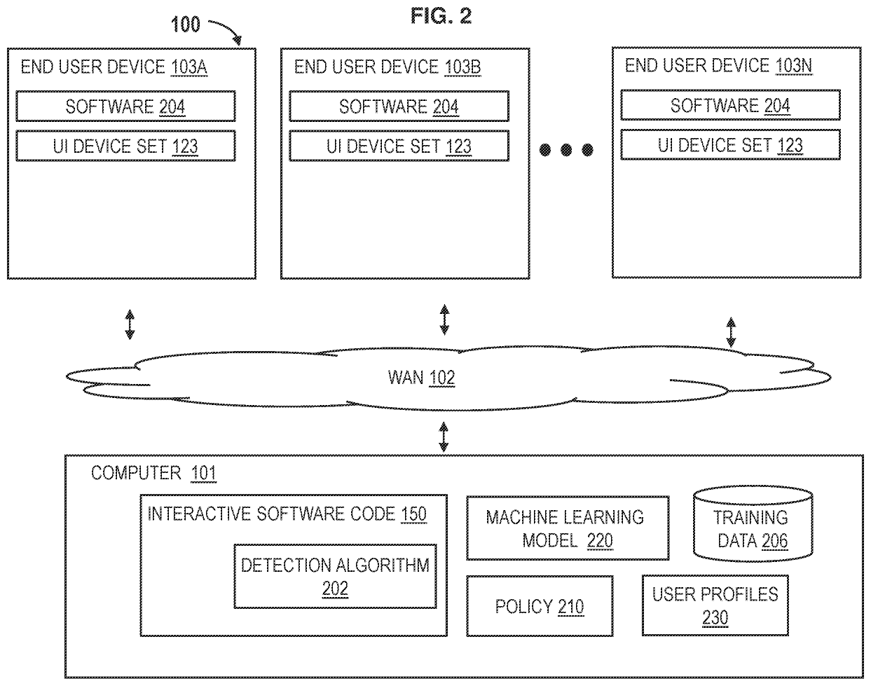

FIG. 2 depicts a block diagram of an example computing environment 100 with further details for monitoring a metaverse collaborative environment upon a condition being met and performing actions to alleviate a security violation in the metaverse collaborative environment according to one or more embodiments. In FIG. 2 and other figures herein, some details of the computing environment 100 may be omitted so as not to obscure the figure while new details are presented. The computer 101 can be representative of many computers cooperatively working to provide services for virtual reality to users of end user devices 103A, 103B, through 103N (generally referred to as end user devices 103) in FIG. 2. The computer 101 can include the interactive software code 150 for monitoring a context of a metaverse collaborative environment, monitoring inside the metaverse collaborative environment upon a condition being met, and then performing actions to alleviate or stop a security violation in the metaverse collaborative environment. The end user devices 103A-103N can include software 204 for accessing and using the virtual reality services provided by the computer 101. Although not shown for the conciseness, the end user devices 103A-103N may include any of the functionality discussed in FIG. 1 for the computer 101. Moreover, the end user devices 103A-103N may include any of the hardware or software of computer 101 discussed in FIG. 1.

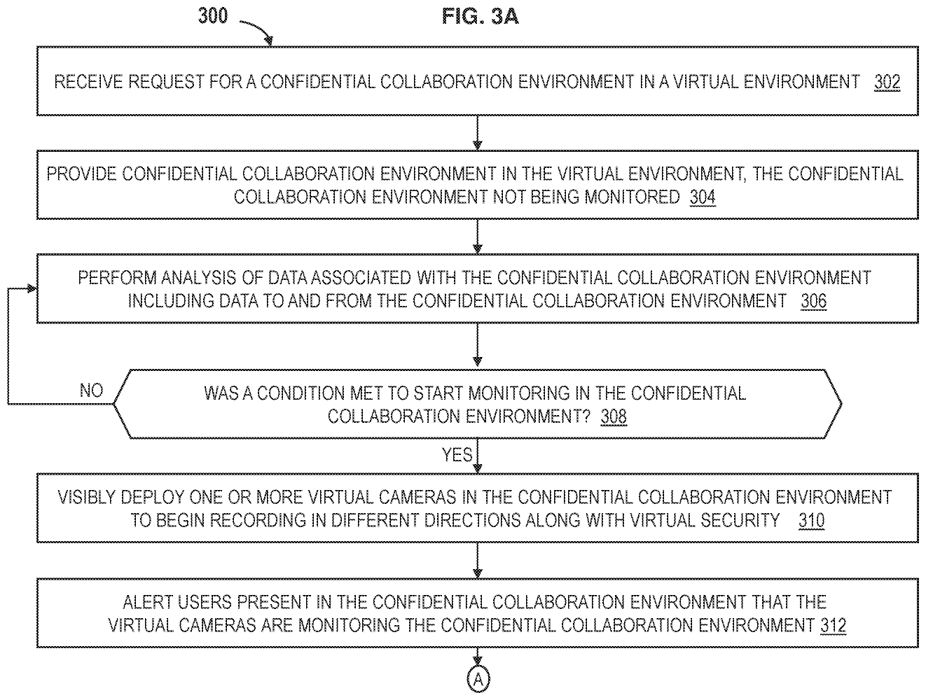

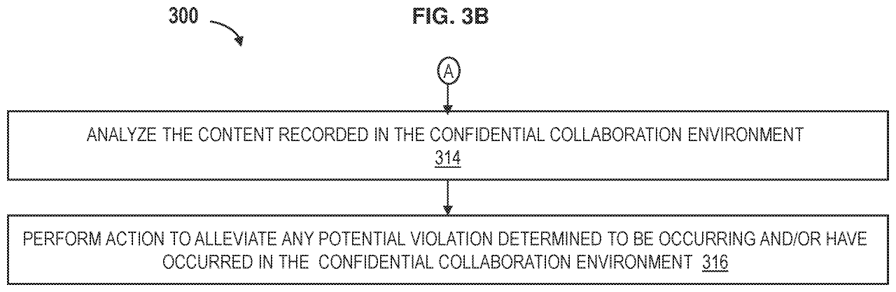

FIGS. 3A and 3B are a flowchart of a computer-implemented method 300 for monitoring a context of a metaverse collaborative environment, monitoring inside the metaverse collaborative environment upon a condition being met, and then performing actions to alleviate or stop a security violation in the metaverse collaborative environment according to one or more embodiments. Reference can be made to any of the figures discussed herein.

At block 302 of the computer-implemented method 300, the interactive software code 150 of the computer 101 is configured to receive a request for providing a confidential collaboration environment, such as a virtual room, in a virtual reality environment.

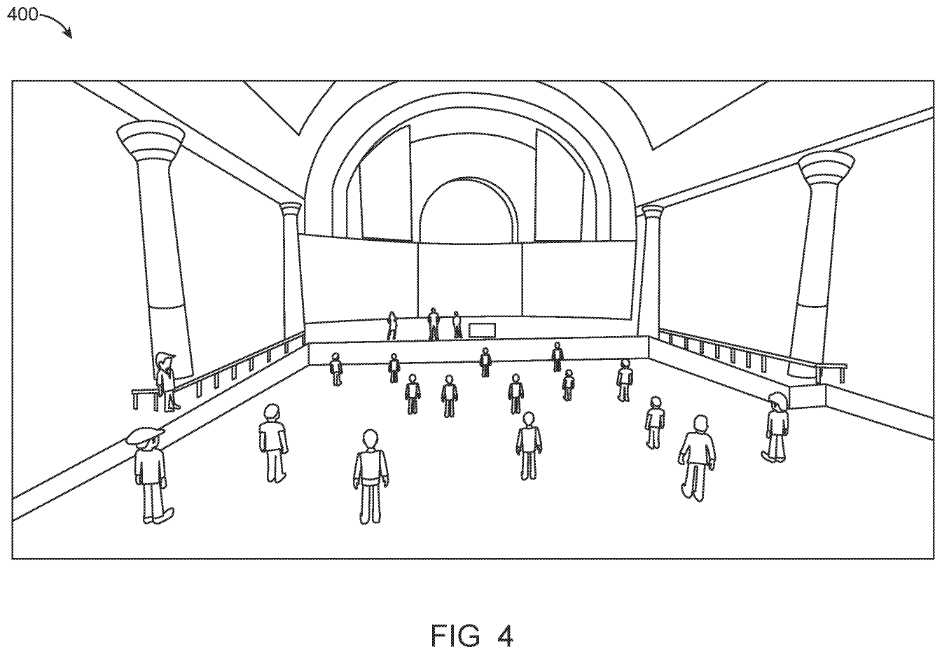

At block 304, the interactive software code 150 of the computer 101 is configured to provide or render the confidential collaboration environment in the virtual reality environment, where the inside of the confidential collaboration environment is not to be monitored. The computer 101 is configured to provide virtual reality services as understood by one of ordinary skill in the art. In an example scenario, the end user device 103A sends a request to the computer 101 to create a virtual room as a confidential collaboration environment in the virtual environment. Accordingly, the computer 101 provides a virtual room 400 as the confidential collaboration environment in which no monitoring occurs, as depicted in FIG. 4. Moreover, since the virtual room 400 is confidential, the interactive software code 150 is not monitoring the activities occurring within the virtual room 400. Because of the request for the confidential collaboration environment, the interactive software code 150 does not monitor inside the virtual room 400. Not monitoring inside the virtual room 400 may include not entering virtual room 400, not viewing in the virtual room 400, not listen in the virtual room 400, no interact in the virtual room 400, and/or not recording content within the virtual room 400, because the confidential collaboration environment is created as a confidential and secure room. There can be cases where a medical provider, legal service provider, and employer may wish to have a confidential and secure room in which virtual service provider is not monitoring insider the confidential collaboration environment.

In one or more embodiments, the virtual room 400 is agreed upon to be confidential in accordance with operating procedures and terms in a policy 210. In one or more embodiments, the policy 210 can be a smart contract and/or smart contract rule stored in a blockchain ledger. The user of the end user device 103A can subscribe for the confidential collaboration environment, as the virtual room 400, in accordance with the policy 210. Various participants using their respective end user devices 103 can enter and interact in the virtual room 400. In one or more embodiments, the smart contract (e.g., policy 210) can be defined to identify which collaboration environment is to be monitored and identify the need for monitoring with virtual cameras. The smart contract can account for the number of participants, location of participants, and streaming context.

At block 306, the interactive software code 150 of the computer 101 is configured to monitor a context of the confidential collaboration environment and perform analysis on the context of the confidential collaboration environment, such as the virtual room 400, without monitoring in the confidential collaboration environment. The context is external to the virtual room 400. Because of the confidentiality for not monitoring in the confidential collaboration environment, the interactive software code 150 may not enter, view, listen to, interact with, and/or record the content within the virtual room 400, which is the confidential collaboration environment in this example. However, when one or more conditions are met in the policy 210, the interactive software code 150 can then monitor inside the virtual room 400, which can include entering, viewing, listening to, interacting in, and/or recording content in the virtual room 400. The content can include media, avatars, conversations, etc., along with any information available in the virtual room 400.

While monitoring the context of the confidential collaboration environment without monitoring the inside of the confidential collaboration environment, any of the following can be utilized to meet a condition to start monitoring inside the virtual room 400. Meeting a condition to start monitoring inside the virtual room 400 can include meeting a predetermined number of participants of end user devices 103 accessing/entering the virtual room 400, determining that a user profile 230 contains predetermined suspicious information for any of the participants of end user devices 103 in the virtual room 400, determining that a network and/or IP address is associated with predetermined suspicious activity for any of the end user devices 103 of the participants, etc. Also, meeting a condition to start monitoring inside the virtual room 400 can include the transfer of a file to the virtual room 400 in which a size of the file meets a predetermined size, the file is a predetermined type, the file contains malware, the file was transferred from predetermined suspicious network address, IP address, and/or geographic location, etc. The respective user profiles 230 of end user devices 103 of the participants may include their network address, IP address, geographic location, log in and log out information, friends/connections, etc. Other conditions can be met to start monitoring inside the virtual room 400. The interactive software code 150 can monitor data to and from the virtual room as the context to determine that a condition is met to start monitoring inside the virtual room 400.

Moreover, monitoring the context of the confidential collaboration environment includes performing streaming analysis on the data to and from the confidential collaboration environment (e.g., virtual room 400) in the virtual environment in order to determine if monitoring inside the confidential collaboration environment is to be performed. The data analyzed during the streamlining analysis is not stored, for example, on the computer 101, and is used for evaluating whether conditions are meet for subsequently monitoring inside the confidential collaboration environment.

In one or more embodiments, the interactive software code 150 can include, employ, and/or call a detection algorithm 202 to monitor the context of the virtual room 400 without monitoring inside the virtual room 400. The detection algorithm can use rules-based logic to determine when one or more conditions are met to begin monitoring inside the virtual room 400. In one or more embodiments, the interactive software code 150 can include, employ, and/or call a machine learning model 220 to monitor the context of the virtual room 400 without monitoring inside the virtual room 400. The machine learning model 220 may include a deep learning model trained for network traffic monitoring and analysis. The machine learning model 220 can include pre-trained models.

In one or more embodiments, the machine learning model 220 can include a neural network trained on training data 206 that includes the contexts of past virtual rooms that met the conditions for monitoring inside the virtual rooms. The training data 206 can include feature vectors labeled as meeting conditions for suspicious activity without monitoring inside the virtual room. The feature vectors of the training data 206 may include a predetermined number of participants of end user devices 103 accessing/entering the virtual room, user profiles 230 containing predetermined suspicious information for any of the participants of end user devices 103 in the virtual room, network and/or IP address associated with predetermined suspicious activity for any of the end user devices 103 of the participants, etc. Feature vectors for the training data 206 may include files to the virtual room 400 in which a size of the file meets a predetermined size, the file is a predetermined type, the file was transferred from predetermined suspicious network address, IP address, and/or geographic location, the file contains malware, etc. The machine learning algorithm(s) of the machine learning model 220 is trained on the training data 206 to result in a trained machine learning model 220 configured to monitor the context of the confidential collaboration environment (e.g., virtual room 400), in order to output (e.g., classify) when a condition for suspicious activity is met.

Referring to FIG. 3A, at block 308, the interactive software code 150 of the computer 101 is configured to check whether any condition was met to start monitoring in the confidential collaborative environment. If not (NO), the flow returns to block 306.

At block 310, if (YES) a condition was met to start monitoring in the confidential collaborative environment, the interactive software code 150 of the computer 101 is configured to visibly and/or audibly deploy one or more virtual cameras in the confidential collaborative environment to begin monitoring at different locations within the confidential collaborative environment. Meeting the condition to start monitoring in the confidential collaborative environment follows the policy 210. In one or more embodiments, the virtual cameras can be added in the confidential collaborative environment to monitor different viewing directions. Additionally, the interactive software code 150 can deploy virtual security in the confidential collaborative environment. Deploying the virtual cameras and/or deploying the virtual security inside the confidential collaborative environment includes entering, viewing, listening to, interacting with, and/or recording the content (including participants) within the virtual room 400. In one or more embodiments, the virtual security can include virtual mobile cameras that move from one direction to another direction, capturing the surrounding areas in the confidential collaborative environment.

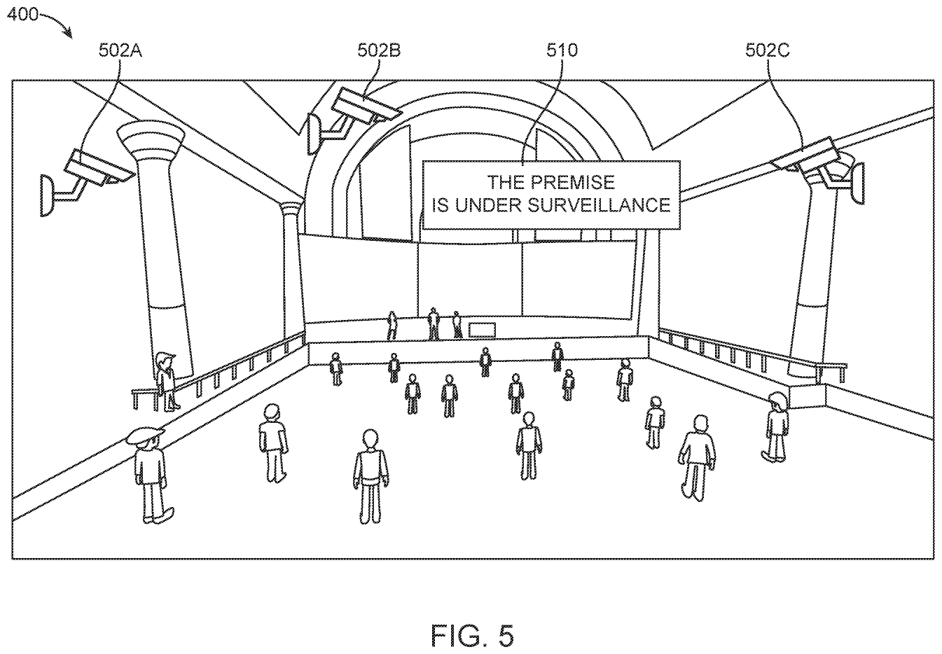

FIG. 5 depicts an example of the virtual room 400 with monitoring being performed within virtual room 400 in response to one or more of the conditions being met for monitoring inside the virtual room 400. As can be seen in FIG. 5, example virtual cameras 502A, 502B, and 502C have been deployed for monitoring inside the virtual room 400. In the example scenario, streaming analysis has been performed for the confidential collaborative environment, and based on the streaming analysis, the interactive software code 150 has identified that the confidential collaborative environment meets the condition for monitoring. Accordingly, the interactive software code 150 deploys an appropriate number of virtual cameras, such that the coverage captures the surrounding for monitoring. More virtual cameras are added when the suspicious activity falls in a category that requires more virtual cameras.

In one or more embodiments, the interactive software code 150 can place different types of virtual cameras in different portions of the confidential collaborative environment. Based on the types of the context of confidential collaborative environment and level of criticality, the interactive software code 150 can identify the number of virtual cameras to be placed in the confidential collaborative environment. In one or more embodiments, the virtual camera may be placed in one or more surrounding areas without violating the privacy of the participants and/or according to the policy 210. The interactive software code 150 continues analyzing the change in the context of confidential collaborative environment and identifies when monitoring coverage is to be increased, for example, by adding more virtual cameras.

Further regarding virtual cameras is discussed below. In the collaborative environment, the virtual cameras refer to a digital viewpoint within a virtual reality environment. The virtual cameras capture content (e.g., video, audio, images, communications, interactions, etc.) as a virtual representation of a camera that allows users to observe and capture the virtual world from different perspectives. In one or more embodiments, virtual cameras in the collaborative environment of the virtual reality environment enable users to view the virtual environment from a first-person perspective and/or third-person perspective, simulating the experience of being present in the virtual space. The virtual cameras in the collaborative environment monitor content within the virtual environment. The virtual cameras capture and record videos, images, and live streams of the virtual environment, which can be shared or used for various purposes such as storytelling, documentation, etc., along with the detection of security violations. The virtual cameras within the virtual environment provide multiple perspectives and camera angles for capturing and streaming virtual performances, conferences, exhibitions, and other interactive experiences. When operating virtual cameras in the virtual environment, notifications are displayed and highlighted to identify which areas are being recorded in the virtual environment.

In one or more embodiments, the virtual cameras in the virtual environment can be controlled by the creator of the collaborative environment, such as the user of end user device 103A, allowing the user to adjust his/her viewpoint, zoom in or out, and explore the virtual world based on his/her preferences. This customization enhances the user's sense of agency and immersion in the virtual environment. The virtual cameras in the virtual environment capture the surrounding area, and the captured content can be analyzed by different media content analysis systems.

Returning to FIG. 3A, at block 312, the interactive software code 150 of the computer 101 is configured to alert participants using end user devices 103 in the confidential collaborative environment that the virtual cameras are monitoring in the confidential collaborative environment. As illustrated in FIG. 5, one or more alerts 510 can be displayed in the virtual room 400 in which the alerts 510 illustrate that virtual cameras are being utilized and the premise is under observation. In one or more embodiments, warning can be audibly played in the virtual room 400 when an avatar of a participant is within a predetermined proximity of the viewing area of a virtual camera.

Referring to FIG. 3B, at block 314, the interactive software code 150 of the computer 101 is configured to analyze the captured content in the confidential collaborative environment for a security violation.

At block 316, in response to detecting that a security violation has occurred based on the analysis of the content, the interactive software code 150 of the computer 101 is configured to perform an action to alleviate or stop the security violation. The actions to alleviate or stop the security violation can include removing one or more participants using end user devices 103 from the virtual environment, suspending access to the virtual room 400, restricting access (e.g., view, interaction, etc.) to one or more portions of the content in the virtual room 400, contacting the administrator, for example, the user of the end user device 103A that one or more pieces of content has to be removed from the virtual room 400, reporting the content to one or more authorities (e.g., government agencies), verifying age requirements of participants of the virtual room 400, etc.

The interactive software code 150 is configured to identify any anomaly (e.g., security violation) in the confidential collaboration environment and report the same to a security team/administrator. In one or more embodiments, the interactive software code 150 can use blockchain to identify the detail about the monitoring and the reporting. Authorized personnel (e.g., security team/administrator) are able to view the anomaly in the confidential collaboration environment for appropriate action. In one or more embodiments, the virtual reality service provider can also stop the confidential collaboration, if the identified anomaly meets any specific pattern, and block the participants from joining in the virtual environment.

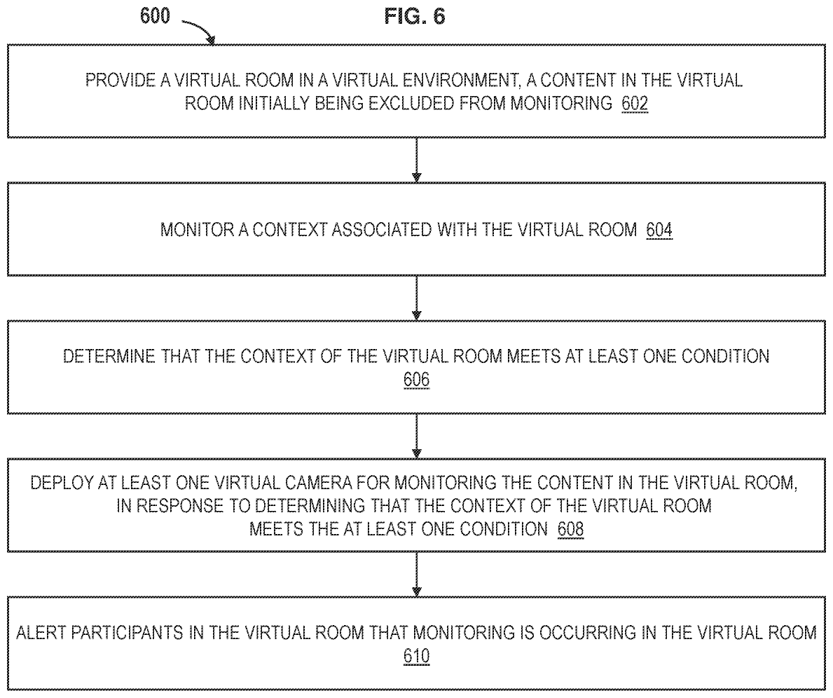

FIG. 6 is a flowchart of a computer-implemented method 600 for monitoring a context of a metaverse collaborative environment, upon a trigger (e.g., one or more conditions being met) monitoring inside the metaverse collaborative environment, and performing actions to alleviate a violation in the metaverse collaborative environment according to one or more embodiments. Reference can be made to any figures discussed herein.

At block 602, the interactive software code 150 is configured to provide a virtual room 400 in the virtual environment, a content in the virtual room initially being excluded from monitoring. Content can include any information and/or interactions occurring in the virtual room 400, including but not limited to media (e.g., video, audio, images, etc.), communications (e.g., text and audio communications), etc. At block 604, the interactive software code 150 is configured to monitor and/or cause the monitoring of a context associated with the virtual room 400. At block 606, the interactive software code 150 is configured to determine that the context of the virtual room 400 meets at least one condition. At block 608, the interactive software code 150 is configured to deploy at least one virtual camera 502A, 502B, and/or 502C for monitoring the content in the virtual room 400, in response to determining that the context of the virtual room 400 meets the at least one condition. At block 610, the interactive software code 150 is configured to alert participants (e.g., users of end user devices 103) in the virtual room 400 that monitoring is occurring in the virtual room 400.

In one or more embodiments, monitoring the context associated with the virtual room 400 includes analyzing data communicated to and from the virtual room to determine that the at least one condition is met. Monitoring the context associated with the virtual room 400 includes analyzing a number of the participants entering the virtual room to determine that the at least one condition is met. Monitoring the context associated with the virtual room 400 includes analyzing user profiles 230 of the participants entering the virtual room 400 to determine that the at least one condition is met.

The at least one virtual camera 502A, 502B, and/or 502C is deployed at various locations in the virtual room 400 to monitor the content based on a view of the at least one virtual camera at the various locations. The content monitored in the virtual room is used to determine that an action is to be performed to stop a security violation. The virtual room 400 is a confidential virtual room that is provided according to a policy 210 for not monitoring the content in the virtual room 400, and monitoring the context associated with the virtual room 400 is performed without initially monitoring in the virtual room 400 and without entering the virtual room 400.

In one or more embodiments, the machine learning model 220 can include various engines/classifiers and/or can be implemented on a neural network. The features of the engines/classifiers can be implemented by configuring and arranging the computer system 101 to execute machine learning algorithms. In general, machine learning algorithms, in effect, extract features from received data in order to “classify” the received data. Examples of suitable classifiers include but are not limited to neural networks, support vector machines (SVMs), logistic regression, decision trees, hidden Markov Models (HMMs), etc. The end result of the classifier's operations, i.e., the “classification,” is to predict a class (or label) for the data. The machine learning algorithms apply machine learning techniques to the received data in order to, over time, create/train/update a unique “model.” The learning or training performed by the engines/classifiers can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier. Unsupervised learning can utilize additional learning/training methods including, for example, clustering, anomaly detection, neural networks, deep learning, and the like.

In one or more embodiments, the engines/classifiers are implemented as neural networks (or artificial neural networks), which use a connection (synapse) between a pre-neuron and a post-neuron, thus representing the connection weight. Neuromorphic systems are interconnected elements that act as simulated “neurons” and exchange “messages” between each other. Similar to the so-called “plasticity” of synaptic neurotransmitter connections that carry messages between biological neurons, the connections in neuromorphic systems such as neural networks carry electronic messages between simulated neurons, which are provided with numeric weights that correspond to the strength or weakness of a given connection. The weights can be adjusted and tuned based on experience, making neuromorphic systems adaptive to inputs and capable of learning. After being weighted and transformed by a function (i.e., transfer function) determined by the network's designer, the activations of these input neurons are then passed to other downstream neurons, which are often referred to as “hidden” neurons. This process is repeated until an output neuron is activated. Thus, the activated output neuron determines (or “learns”) and provides an output or inference regarding the input.

Training datasets (e.g., training data 206) can be utilized to train the machine learning algorithms. The training datasets can include historical data of past tickets and the corresponding options/suggestions/resolutions provided for the respective tickets. Labels of options/suggestions can be applied to respective tickets to train the machine learning algorithms, as part of supervised learning. For the preprocessing, the raw training datasets may be collected and sorted manually. The sorted dataset may be labeled (e.g., using the Amazon Web Services® (AWS®) labeling tool such as Amazon SageMaker® Ground Truth). The training dataset may be divided into training, testing, and validation datasets. Training and validation datasets are used for training and evaluation, while the testing dataset is used after training to test the machine learning model on an unseen dataset. The training dataset may be processed through different data augmentation techniques. Training takes the labeled datasets, base networks, loss functions, and hyperparameters, and once these are all created and compiled, the training of the neural network occurs to eventually result in the trained machine learning model (e.g., trained machine learning algorithms). Once the model is trained, the model (including the adjusted weights) is saved to a file for deployment and/or further testing on the test dataset.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
providing a virtual room in a virtual environment, a content in the virtual room initially being excluded from monitoring;
monitoring a context associated with the virtual room;
determining that the context of the virtual room meets at least one condition;
deploying at least one virtual camera for monitoring the content in the virtual room, in response to determining that the context of the virtual room meets the at least one condition; and
alerting participants in the virtual room that monitoring is occurring in the virtual room.

2. The computer-implemented method of claim 1, wherein monitoring the context associated with the virtual room comprises analyzing data communicated to and from the virtual room to determine that the at least one condition is met.

3. The computer-implemented method of claim 1, wherein monitoring the context associated with the virtual room comprises analyzing a number of the participants entering the virtual room to determine that the at least one condition is met.

4. The computer-implemented method of claim 1, wherein monitoring the context associated with the virtual room comprises analyzing user profiles of the participants entering the virtual room to determine that the at least one condition is met.

5. The computer-implemented method of claim 1, wherein the at least one virtual camera is deployed at various locations in the virtual room to monitor the content based on a view of the at least one virtual camera at the various locations.

6. The computer-implemented method of claim 1, wherein the content monitored in the virtual room is used to determine that an action is to be performed to stop a security violation.

7. The computer-implemented method of claim 1, wherein:
the virtual room is a confidential virtual room that is provided according to a policy for not monitoring the content in the virtual room; and
monitoring the context associated with the virtual room is performed without initially monitoring in the virtual room and without entering the virtual room.

8. A system comprising:
a memory having computer readable instructions; and
a computer for executing the computer readable instructions, the computer readable instructions controlling the computer to perform operations comprising:
providing a virtual room in a virtual environment, a content in the virtual room initially being excluded from monitoring;
monitoring a context associated with the virtual room;
determining that the context of the virtual room meets at least one condition;
deploying at least one virtual camera for monitoring the content in the virtual room, in response to determining that the context of the virtual room meets the at least one condition; and
alerting participants in the virtual room that monitoring is occurring in the virtual room.

9. The system of claim 8, wherein monitoring the context associated with the virtual room comprises analyzing data communicated to and from the virtual room to determine that the at least one condition is met.

10. The system of claim 8, wherein monitoring the context associated with the virtual room comprises analyzing a number of the participants entering the virtual room to determine that the at least one condition is met.

11. The system of claim 8, wherein monitoring the context associated with the virtual room comprises analyzing user profiles of the participants entering the virtual room to determine that the at least one condition is met.

12. The system of claim 8, wherein the at least one virtual camera is deployed at various locations in the virtual room to monitor the content based on a view of the at least one virtual camera at the various locations.

13. The system of claim 8, wherein the content monitored in the virtual room is used to determine that an action is to be performed to stop a security violation.

14. The system of claim 8, wherein:
the virtual room is a confidential virtual room that is provided according to a policy for not monitoring the content in the virtual room; and
monitoring the context associated with the virtual room is performed without initially monitoring in the virtual room and without entering the virtual room.

15. A computer program product comprising a computer readable storage medium having program instructions embodied therewith, the program instructions executable by a computer to cause the computer to perform operations comprising:
providing a virtual room in a virtual environment, a content in the virtual room initially being excluded from monitoring;
monitoring a context associated with the virtual room;
determining that the context of the virtual room meets at least one condition;
deploying at least one virtual camera for monitoring the content in the virtual room, in response to determining that the context of the virtual room meets the at least one condition; and
alerting participants in the virtual room that monitoring is occurring in the virtual room.

16. The computer program product of claim 15, wherein monitoring the context associated with the virtual room comprises analyzing data communicated to and from the virtual room to determine that the at least one condition is met.

17. The computer program product of claim 15, wherein monitoring the context associated with the virtual room comprises analyzing a number of the participants entering the virtual room to determine that the at least one condition is met.

18. The computer program product of claim 15, wherein monitoring the context associated with the virtual room comprises analyzing user profiles of the participants entering the virtual room to determine that the at least one condition is met.

19. The computer program product of claim 15, wherein the at least one virtual camera is deployed at various locations in the virtual room to record the content based on a view of the at least one virtual camera at the various locations.

20. The computer program product of claim 15, wherein the content monitored in the virtual room is used to determine that an action is to be performed to stop a security violation.
